(19) United States
(12) Patent Application Publication
(10) Pub. No.: US 2013/0022075 A1
(43) Pub. Date: Jan. 24, 2013

(54) TEMPERATURE SENSOR HAVING MEANS FOR IN-SITU CALIBRATION

(71) Applicants: Detlef PAPE, Nussbaumen (CH); Gian-Luigi MADONNA, Otelfingen (CH); Yannick MARET, Dattwil (CH)

(72) Inventors: Detlef PAPE, Nussbaumen (CH); Gian-Luigi MADONNA, Otelfingen (CH); Yannick MARET, Dattwil (CH)

(73) Assignee: ABB Technology AG, Zurich (CH)

(21) Appl. No.: 13/552,300

(22) Filed: Jul. 18, 2012

(30) Foreign Application Priority Data
Jul. 18, 2011 (DE) 102011107856.1

(51) Int. Cl. G01K 15/00

(52) U.S. Cl. 374/1; 374/E15.001

(57) ABSTRACT

A temperature sensor is disclosed as having a resistance thermocouple, accommodated in a sensor housing, for detecting a process temperature. The thermocouple can be connected via a multipole electric line to an electronic temperature transmitter for measured-value conditioning, the resistance thermocouple being equipped for in-situ calibration with a Johnson noise thermometer for determination of a reference temperature.

### RELATED APPLICATION

This application claims priority under 35 U.S.C. §119 to German Patent Application No. 10 2011 107 856.1 filed in Germany on Jul. 18, 2012, the entire content of which is hereby incorporated by reference in its entirety.

### FIELD

This disclosure relates to a temperature sensor, such as a temperature sensor having a resistance thermocouple, accommodated in a sensor housing, for detecting a process temperature, which thermocouple is connected via a multipole electric line to an electronic temperature transmitter for measured-value conditioning, the resistance thermocouple being equipped with in-situ calibration.

### BACKGROUND

The field of industrial and laboratory applications can involve precise temperature measurement over a long time. Use is made in this field of application of temperature sensors that are, for example, designed as resistance thermometers. The resistance thermometers can be electric components that employ the temperature dependence of the electrical resistance of conductors in order to measure temperature. High-precision temperature measurement can be subject to the drift and the aging of the sensor elements. The material characteristics of the sensor element can change owing to the effect of high temperatures, mechanical vibrations, aggressive media or radioactive radiation. These influences can have an effect on the long-term accuracy of the sensor element such that the sensor element should be calibrated regularly at periodic intervals in order to obtain a high measurement accuracy.

In accordance with known art, sensor elements are dismounted for calibration and reset with the aid of a special calibration unit. The calibration unit can include a temperature-controlled hot bath, and the output signal of the sensor element to be calibrated is compared with the temperature of the hot bath. As a consequence of the measurement result, there is determined for the sensor element a new calibration curve that is used for measured-value compensation during the further use of the sensor element. However, such a calibration procedure can be very complicated, since calibration involves dismounting the sensor element at the place of use. It frequently happens that the entire production process has to be interrupted during the calibration of the sensor element, and this can lead to production outages. A so-called in-situ calibration of the sensor element can omit dismounting the sensor element.

U.S. Pat. No. 3,499,310 discloses a special temperature sensor that is equipped with means for in-situ calibration. To this end, the sensor element located inside the sensor housing is provided with an adjacent heating element. A material with a specific melting point is located in the region between the heating element and sensor element. In this case, the sensor element is in thermal contact both with the surroundings of the sensor housing and with the heating element and the special material surrounding the latter. During normal measurement operation, the temperature is determined by the sensor element in a way known per se. For the purpose of calibration of the sensor element, the heating element raises the temperature of the sensor element above the melting point of the special material. As the sensor element is being heated up, the measured temperature rises continuously until the melting point of the material surrounding the sensor element is reached. When the material begins to melt, the thermal energy of the heating element is consumed in order to melt the material, the result being a delayed temperature rise. This delay can be determined outside the time lapse of the temperature measurement, and can be used to calibrate the sensor element. It is hereby possible to carry out an in-situ calibration of the temperature sensor without dismounting the sensor from the place of use.

However, an additional heating element has to be accommodated inside the sensor housing. This involves an additional space in the sensor housing, something which normally increases the geometric dimensions of the sensor housing. This can lead to restrictions on the use of such temperature sensors. Moreover, the additional heating element and its wiring as well as additional thermal insulation means increase the weight of the temperature sensor and can impair the thermal resistance between the sensor element and the surroundings, thus reducing the response time of the temperature sensor to the change of temperature that is to be measured.

### SUMMARY

A temperature sensor is disclosed comprising: a resistance thermo-couple accommodated in a sensor housing, for detecting a process temperature; and a multipole electric line for connecting the thermocouple to an electronic temperature transmitter for measured-value conditioning, the resistance thermocouple being equipped with means for in-situ calibration, wherein the means for in-situ calibration includes a Johnson noise thermometer for determination of a reference temperature.

### BRIEF DESCRIPTION OF THE DRAWINGS

Exemplary features and advantages will be better understood from the following detailed description when read in conjunction with the attached drawings:

FIG. 1 shows a schematic front view of an exemplary temperature sensor having a resistance thermocouple and means for in-situ calibration; and

FIG. 2 shows a block diagram of an exemplary arrangement according to FIG. 1.

### DETAILED DESCRIPTION

An exemplary temperature sensor is disclosed which is equipped with a resistance thermocouple with means for in-situ calibration, which temperature sensor can ensure highly accurate calibration without the need for additional space in the sensor housing.

Exemplary embodiments involve the technical teaching that the means for in-situ calibration include a Johnson noise thermometer for determining the reference temperature. An exemplary advantage is that the Johnson noise thermometer may be presented as an additional electronic unit that is either permanently integrated in the electronic temperature transmitter of the temperature sensor, or can also be connected to the temperature sensor only temporarily for the purpose of calibration, and can to this extent serve as an optional supplementary electronic unit. Johnson noise, which is also denoted as thermal noise, is random white noise that is produced by thermal excitation of electrons in a conductor or in an electronic component, specifically irrespective of the applied voltage. It can be proportional to the absolute temperature of the conductor. The amplitude of the signal corresponds to a Gaussian probability density. In principle, the thermal noise is independent of the material of the sensor. Given a known resistance and power spectral density (PSD) of the thermal noise, the temperature can be determined with high accuracy and without drift due to a change in material characteristics. Since thermal noise signals are extremely small and very sensitive to interference, in industrial practice there are no exclusive applications for temperature measurement. It is mostly high-precision Johnson noise thermometers (JNT) that are used in meteorological laboratories with a low-noise environment, in conjunction with the use of high-quality electronic test instruments. In addition, applications are also known for nuclear power plants, but with less precision than for the meteorological purposes.

U.S. Pat. No. 5,228,780 discloses a known application of Johnson noise in the form of a dual-mode thermometer. Here, the temperature is determined, firstly, on the basis of Johnson noise and, secondly, on the basis of a material resistance, this being done simultaneously and continuously with the same probe. The temperature determined via Johnson noise is used to adjust the temperature determined via the material resistance. This technique combines the fast measured-value acquisition on the basis of resistance measurement with the thermal long-term stability of the Johnson noise measurement. The overall system for using the resistance thermocouple can, however, be quite complex. Owing to the small signal amplitude of Johnson noise measurement, and to the avoidance of signal losses, Johnson noise measurement is an integrated component of the sensor system and cannot be removed therefrom. Consequently, this known temperature sensor is configured as a complete measurement system.

As disclosed herein, exemplary embodiments can be based on a finding that a Johnson noise thermometer comes into use only at the instant of a desired calibration of the resistance thermocouple.

In accordance with a measure of alternative embodiments, it is proposed that a means for in-situ calibration comprise a current buffer unit for covering a temporary multicurrent requirement during a calibration cycle via the Johnson noise thermometer. This is because the current consumption of a Johnson noise thermometer is much higher than the current consumption of a resistance thermocouple. Since, on the other hand, the calibration is desired only at relatively large time intervals, the current specification need not be dimensioned by using the higher current requirement of the Johnson noise thermometer. Instead of this, it suffices when a current buffer unit, for example an electrical battery, is brought into use to cover the temporary multiple current specification.

The multipole electric line for an exemplary temperature sensor as disclosed herein can also be designed as a 30 mW line in view of the measure presented above. The temperature sensor can therefore be used in the context of standardized applications employing, for example, 30 mW technology.

It is, furthermore, proposed that the multipole electric line between the resistance thermocouple and the electronic temperature transmitter be embodied using, for example, four-wire technology. In four-wire technology, a known current flows through the resistor via two of the lines. The voltage falling across the resistor is tapped at high resistance via two further lines and measured with the aid of a voltage measuring instrument, and the resistance to be measured is calculated therefrom using Ohm's law. Measuring errors resulting from the resistances of the live instrument leads or the contact points can be thereby avoided. In addition, the multipole electric line can also be embodied as a shielded line at whose distal end it is possible to arrange the resistance thermocouple in a directly integrated fashion. The shielding of the multipole electric line can inhibitor prevent corruption of measured values through electro-magnetic interference in the line itself, as well as the resistance thermocouple. Owing to the accommodation in the common shielded line, the resistance thermocouple can be directly integrated in the line in a space-saving fashion.

In accordance with another measure of alternate exemplary embodiments, means for in-situ calibration be accommodated in a separate calibration unit that can be fastened on the sensor housing. The separate calibration unit can therefore optionally be fastened on the temperature sensor when a calibration is to be carried out. Consequently, the Johnson noise thermometer need not be a permanent constituent of the temperature sensor; it is also possible for the already existing temperature sensors equipped with resistance thermocouples to be calibrated with the aid of such an optional calibration unit during operation. This can involve merely external connections to be supplemented for the separate calibration unit.

The separate calibration unit should, for example, be arranged between the sensor housing and the electronic temperature transmitter via a connection unit, the multipole electric line being guided through the connection unit. Such a connection unit can be made available as a retrofitted component, in order to connect the calibration unit to the temperature sensor in a reliable manner electrically and mechanically. For the purpose of electrical connection, the calibration unit is, for example, connected electrically in parallel to the resistance thermocouple via the connection unit, the connection unit being used in a normal mode as bypass relative to the temperature transmitter and being connected to the resistance thermocouple in one calibration mode, in order to measure the noise current in a defined bandwidth for the purpose of determining the calibration data. In order to correct measured values, the calibration data thus determined can be fed to the electronic temperature transmitter or to a higher-level electronic control unit. In an exemplary normal mode, the connection unit thus constitutes only an electrical connection between the resistance thermocouple and the temperature transmitter. This mode is used for normal temperature measuring operation when the process temperature is measured via the resistance thermocouple. In calibration mode, the Johnson noise thermometer is connected at the resistance thermocouple, in order to determine the noise current of the resistance thermocouple in order to calculate the calibration data. The temperature transmitter can hereby be separated from the resistance thermocouple.

In accordance with another measure of alternate exemplary embodiments, it is proposed that, in order to switch over between an exemplary normal mode and calibration mode there are integrated in the connection unit switching means that can be appropriately designed as multipole mechanical and electrical switches or electronic switches. The temperature transmitter can hereby be separated temporarily from the resistance thermocouple in order to connect the latter as a changeover switch to the Johnson noise thermometer for the purpose of calibration.

In principle, during calibration, the current spectrum at the connection of the resistance thermocouple is monitored. The power spectral density should be constant over the monitored frequency band, and proportional to the square root of the temperature of the resistance thermocouple. In reality, however, this physical relationship is impaired by electromagnetic interference and non-ideal line characteristics of the electrical connection between the resistance thermo-couple and the Johnson noise thermometer.

In order to reduce the influence of the external interference, it is proposed in accordance with a further measure of alternate exemplary embodiments, that the temperature transmitter determines the noise voltages induced in the shielding of the resistance thermocouple, in order to undertake a corresponding correction of the power spectral density.

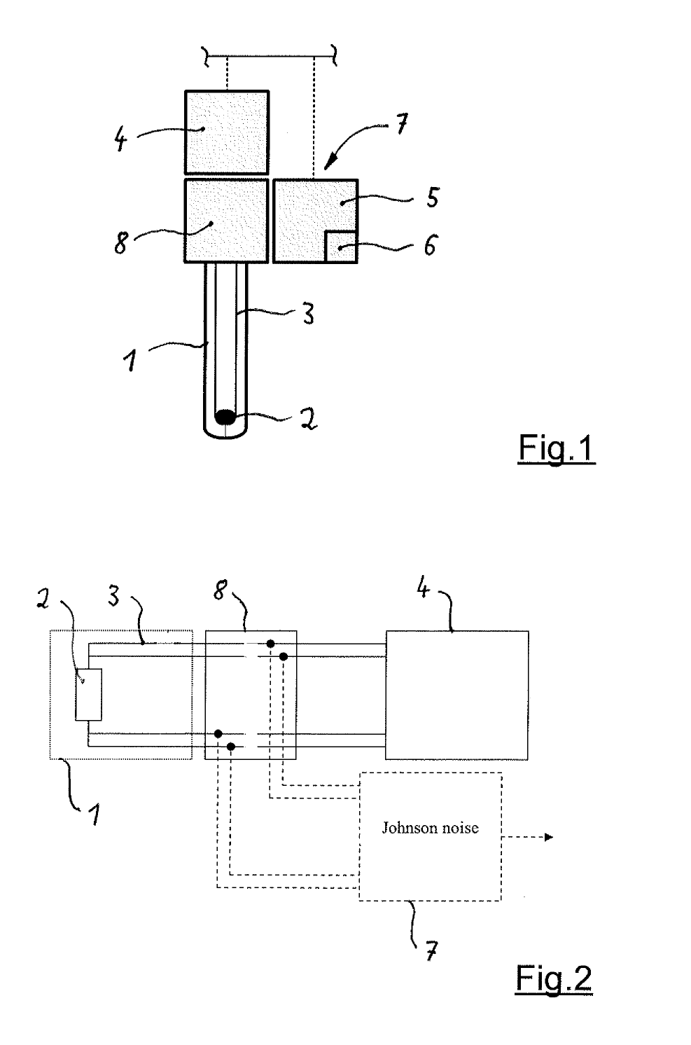

According to FIG. 1, an exemplary temperature sensor has a tubular sensor housing 1 that is made from metal and has a base that is closed in a domed fashion and in the region of which a resistance thermocouple 2 is arranged internally. Outside the sensor housing 1 is located a measuring medium —not further illustrated here—whose temperature is to be determined by the resistance thermocouple 2. For this purpose, the resistance thermocouple 2 is connected to an electronic temperature transmitter 4 via a multipole electric line 3. The electronic temperature transmitter 4 is used to condition measured values and pass them on to a higher-order control unit—not further illustrated.

The resistance thermocouple 2 cooperates with means for in-situ calibration that, according to exemplary embodiments, comprise a Johnson noise thermometer 5 or other suitable device. The Johnson noise thermometer 5 is used to establish the reference temperature for the temperature sensor.

In order to cover during a calibration cycle the increased electrical current, the Johnson noise thermometer 5 can include a current buffer unit 6 that is designed as an electrical battery. During normal temperature measuring operation—that is to say, outside a calibration cycle—the current buffer unit 6 is fed with the electrical energy that flows via the multipole electric line 3. The multipole electric line 3 is embodied as a shielded line at whose distal end the resistance thermocouple 2 is arranged directly in an integrated fashion.

The Johnson noise thermometer 5 is accommodated within a separate calibration unit 7 that is fastened on the sensor housing 1 via a connection unit 8. The connection unit 8 is arranged between the sensor housing 1 and the electronic temperature transmitter 4, and the multipole electric line 3 is guided through the connection unit 8.

According to FIG. 2, an exemplary multipole electric line 3 is embodied using four-wire technology, and forms a 30 mW line in order to connect the resistance thermocouple 2 to the electronic temperature transmitter 4. The connection unit 8 arranged between the sensor housing 1 and the electronic temperature transmitter 4 is used in a normal mode as bypass relative to the temperature transmitter 4, and can be connected in a calibration mode to the resistance thermocouple 2 in order to measure the noise current in a defined bandwidth for the purpose of determining the calibration data. In order to switch over between normal mode and calibration mode, the connection unit 8 is equipped with an appropriate switching means (e.g., known mechanical and/or electrical switch)—not illustrated further.

The temperature transmitter 4 also determines the interference voltages induced in the shielding of the resistance thermocouple 2, in order to undertake a correction of the spectral density of the measurement current of the Johnson noise thermometer 5.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCE NUMERALS

1 Sensor housing
2 Resistance thermocouple
3 Electric line
4 Electronic temperature transmitter
5 Johnson noise thermometer
6 Current buffer unit
7 Calibration unit
8 Connection unit

1. A temperature sensor comprising:
a resistance thermocouple accommodated in a sensor housing, for detecting a process temperature; and
a multipole electric line for connecting the thermocouple to an electronic temperature transmitter for measured-value conditioning, the resistance thermocouple being equipped with means for in-situ calibration, wherein the means for in-situ calibration includes a Johnson noise thermometer for determination of a reference temperature.

2. The temperature sensor as claimed in claim 1, wherein the means for in-situ calibration comprise:
a current buffer unit for covering a temporary multicurrent during a calibration cycle via the Johnson noise thermometer

3. The temperature sensor as claimed in claim 1, wherein the multipole electric line is designed as a 30 mW line.

4. The temperature sensor as claimed in claim 1, wherein the multipole electric line is embodied using four-wire technology.

5. The temperature sensor as claimed in claim 1, wherein the multipole electric line is embodied as a multipole shielded line at whose distal end the resistance thermocouple is arranged in an integrated fashion.

6. The temperature sensor as claimed in claim 1, wherein the Johnson noise thermometer is accommodated in a separate calibration unit that is fitted on the sensor housing.

7. The temperature sensor as claimed in claim 6, wherein the separate calibration unit is arranged between the sensor housing and the electronic temperature transmitter via a connection unit, the multipole electric line being guided through the connection unit.

8. The temperature sensor as claimed in claim 6, wherein the calibration unit is connected electrically in parallel to the resistance thermocouple via the connection unit, the connection unit being configured for a normal mode as a bypass relative to the temperature transmitter and being connected to the resistance thermocouple in a calibration mode for measuring a noise current in a defined bandwidth for determining calibration data.

9. The temperature sensor as claimed in claim 8, wherein the connection unit comprises:
switching means for switching between the normal mode and the calibration mode.

10. The temperature sensor as claimed in claim 1, wherein the temperature transmitter is configured for determining noise voltages induced in shielding of the resistance thermocouple, for correcting spectral density of a measurement current of the Johnson noise thermometer.
